(19) United States
(12) Patent Application Publication
(10) Pub. No.: US 2006/0198977 A1
(43) Pub. Date: Sep. 7, 2006

(54) MAGNETIC TRUCK RAIL PROTECTOR

(76) Inventor: Daniel E. Meservey, Ossipee, NH (US)

Correspondence Address: MESMER & DELEAULT, PLLC, 1 NEW HAMPSHIRE AVE., SUITE 125, PORTSMOUTH, NH, 03801, US

(21) Appl. No.: 11/306,570

(22) Filed: Jan. 3, 2006

Related U.S. Application Data
(60) Provisional application No. 60/593,273, filed on Jan. 3, 2005.
(60) Provisional application No. 60/593,851, filed on Feb. 18, 2005.

(51) Int. Cl. B32B 33/00

(52) U.S. Cl. 428/40.1; 428/99

(57) ABSTRACT

An automobile frame protector that protects a car from deformation and scratches from jacks and rocks, attaches to a car without bolts, rivets, or welding, and can be removed before the car is sold, thereby restoring the car to an as-new condition made of a permanent magnetic strip sufficiently long to span the jacking points of a car and at least about ⅛ inch thick disposed upon the frame on the underside of a car. The strip can also be provided with a coating selected for its anti-abrasion and anti-corrosion characteristics, and an adhesive applied to the side opposite the coated side. Another embodiment uses the strip on a pickup truck rail and tailgate to protect is from damage. Yet another embodiment is to provide the protector in a kit form.

### BACKGROUND

1. Field of the Invention.

The invention is related to accessories that can be added to a motor vehicle to protect it from damage.

2. Description of the Related Art.

In the car rental industry, cars are put into service when they are new. They are operated as rentals for a period of time, typically a year. At the end of that time, they are sold as used cars. However, the car bodies have to be in perfect condition to be sold.

Rental cars are inspected frequently to make sure they are maintained in top condition. This includes a complete underside inspection that requires lifting the cars with jacks. The stresses on the frame where the jack lifts a car are so great that they often deform and scratch the frame, thereby requiring the rental company to perform auto body repair.

Deformation sometimes occurs because the jack operator does not place the jack under the car properly. Sometimes the damage cannot be avoided, even with proper jack placement, because the car frame is weak. Rocks thrown up against the underside of a car during operation may also cause deformations and scratches. In any case, auto body repair involves removing deformations and re-painting the area to exactly match the surrounding surfaces. Even painting is very difficult, since the color will be a little different than when it was new. The color matching has to take a year or so weathering into account.

Typical auto body repairs cost between about US $1500 and $3000. If the repair and paint matching is not successful, the owner usually cannot sell the car.

It is possible to add guards or other protectors to a car. However, the car must be restored to its “as-new” condition to be sold. This precludes the use of bolting, riveting, or welding special guards onto the car.

A related problem is that with placing equipment on or in pickup truck beds. The beds tend to get damaged easily. Yet, permanent guards are expensive and cannot be applied at a moment's notice.

What is needed, therefore, is an automobile frame protector that protects a car from deformation and scratches from jacks and rocks, attaches to a car without bolts, rivets, or welding, and can be removed before the car is sold, thereby restoring the car to an as-new condition without auto body repair.

What is also needed is an inexpensive truck rail protector that can be instantly installed.

### SUMMARY

An invention that satisfies the need for an automobile frame protector that protects a car from deformation and scratches from jacks and rocks, attaches to a car without bolts, rivets, or welding, and can be removed before the car is sold, thereby restoring the car to an as-new condition is a permanent magnetic strip sufficiently long to span the jacking points of a car and at least about ⅛ inch thick. The strip can also have a coating disposed on one surface selected for its anti-abrasion and anti-corrosion characteristics. Another embodiment of the present invention uses the strip on a pickup truck rail and tailgate to protect is from damage. These and other features and embodiments of the invention will be made clear in the following drawing and description.

### DRAWINGS

FIG. 1 is a perspective view of a magnetic frame protector according to the present invention.

FIG. 2 is a plan view of a pickup truck showing the placement location of protectors on the bed rail.

### DESCRIPTION

One embodiment of the invention is an automobile frame protector that protects a car from deformation and scratches from jacks and rocks, attaches to a car without bolts, rivets, or welding, and can be removed before the car is sold, thereby restoring the car to an as-new condition is a permanent magnetic strip sufficiently long to span the jacking points of a car and at least about 0.32 cm (⅛ inch) thick disposed upon the frame on the underside of a car.

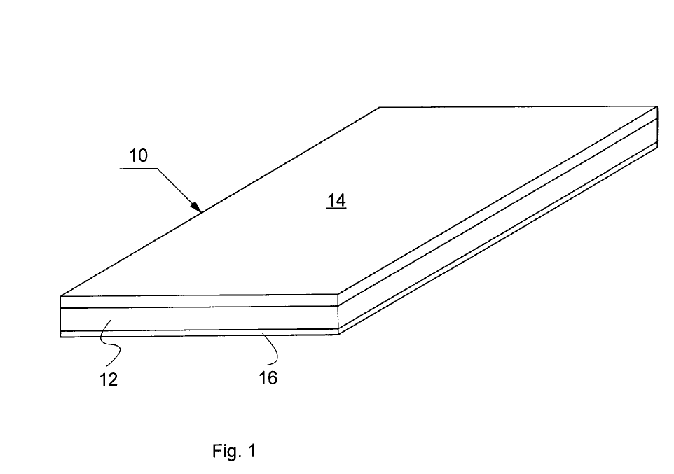

Turning to FIG. 1, the frame protector 10 has a magnetic strip 12 at its core. Provided the frame is made of a magnetic material, like steel, a permanent magnet will adequately adhere to the underside of the car without needing bolts, rivets, or welding.

Testing has led to the adoption of some preferred dimensions for the strip. The strip 12 is preferably about 7.6 cm (3 inches) wide. This width satisfactorily covers the frame jacking areas of most cars without extending beyond the frame.

The preferred thickness of the magnetic strip 12 is about 0.32 cm (⅛ inch) thick. This thickness is preferred because it is thick enough to effectively distribute the load from jacking to surrounding areas of the frame to prevent deformation and scratching. At the same time, it is not so thick that the wind would catch it while the car is driving at high speed, thereby pulling it off of the car. The thickness is also preferred because it is not large enough to be visually noticed when applied to the car. At this thickness it is also sufficiently flexible that it would not cause injury in an accident.

The preferred length is between about 38 cm (15 inches) and 114 cm (45 inches). The length should be long enough to span the jacking points of the car frame. Alternatively, shorter lengths can be used together to make up longer lengths to reduce the need for custom lengths. However, the magnetic strip 12 can also be supplied specially sized for popular models of rental cars.

In one embodiment of the invention, the magnetic strip can be supplied with a coating 14 disposed on at least one surface of the strip. The coating 14 would be selected for its anti-abrasion and anti-corrosion characteristics. One example of a suitable coating 14 is a spray-on polyurethane and polyurea coating sold under the LINE-X trademark, owned by the Burtin Corporation. Other coating materials having similar characteristics could be used.

It can be appreciated that that every strip has two opposing sides. In another embodiment of the present invention, an adhesive 16 can be disposed on the magnetic strip 12 on the side opposite that of the anti-abrasion and anti-corrosion coating 14, if provided. The adhesive 16 would supplement the attractive effect of the magnetic strip 12 to keep the protector 10 on the car while the car is in use. If an adhesive 16 is provided, it would also preferably be provided with a paper backing that can be removed just prior to placing the protector 12 on a car.

A benefit of the present invention is that a pair of protectors 10 will typically cost less than five percent of the cost of an auto body repair. Most often, the cost will only be about one percent of an auto body repair. Furthermore, applying a pair of magnetic protectors 10 to a car will take less than five minutes. This is much less time than it takes to perform an auto body repair, and is certainly less costly.

Another benefit is that the protectors 10 will protect the frame should the car bottom-out while going over uneven terrain or in the event of an accident. The protectors 10 may become scuffed, or even be pulled off and lost. However, the protectors 10 will provide significant protection for at least that event that would otherwise require auto body repair.

In operation, a car rental company with a new rental car will apply a pair of magnetic protectors 10 to the frame rails underneath the car. If provided, the adhesive side will be against the rail, and the coated side will face outward. During the one year that the car is in rental service, the car will be inspected a number of times. The car will be jacked up by its frame, and the frame will be protected by the protectors 10 without any further effort of the rental company. At the end of the car's rental service, the magnetic protectors 10 will be removed, thereby restoring the car to as-new condition. The protectors 10 can then be placed on another new car and re-used.

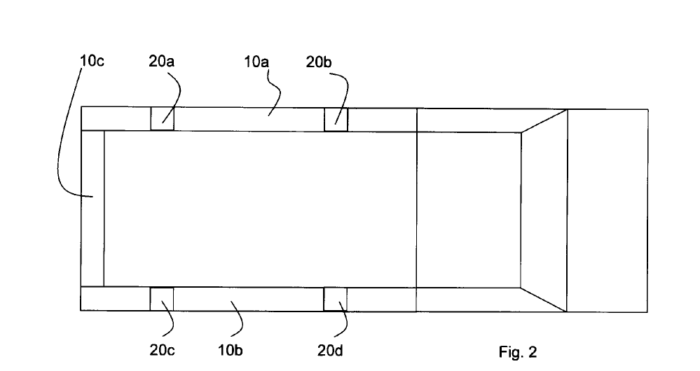

Another embodiment of the present invention uses the same strip 12 having a coating 14 on at least one surface to form a protector 10. Turning to FIG. 2, the protector 10 can be applied to the top of a truck bed rail, where a truck bed would rest. The user can apply the left side protectors 10a around the left side post holes 20a, 20b in the rail, and apply the right side protectors 10b around the right side post holes 20c, 20d so that the protectors do not interfere with their use. In FIG. 2, the left side protector 10a and the right side protector 10b could be provided in three pieces to completely cover the rail, less the post holes. In addition, a tailgate protector 10c can be applied to the end of the truck's tailgate. Another option is to apply smaller pieces of protector 10 along the rail exactly where a load will be placed.

Preferably the width of the strip will be selected to match the width of the rail. The typical width will be 7.6 cm (3 inches), but it can be selected to be wider or narrower depending upon the application.

Another embodiment of the present invention is to provide the protectors 10 as a kit. The user can purchase a combination of protectors in standard widths and lengths. Providing the protectors as a kit would be less expensive than providing custom fitted protectors for every type of truck.

In operation, a user will have a need to apply a bed, equipment, or some type of load on a truck. The user will realize that the load may damage the truck's rail. The user can obtain a kit of protectors and apply them to the rail where the load will be applied. The protectors can be removed and reused after the load is removed. The user has an inexpensive way to immediately protect the truck.

Both embodiments can be provided in a rolled up configuration. In this way, the strips can be shipped and sold very conveniently. If the strips were provided in a flat configuration, they would be unwieldy. Shippers, retailers and consumers would have a difficult time handling them if provided flat. The magnetic strips are flexible to enable them to be rolled up, and the thickness is calculated to make this possible.

While there have been described what are at present considered to be the preferred embodiments of this invention, it will be obvious to those skilled in the art that various changes and modifications may be made therein without departing from the invention and it is, therefore, aimed to cover all such changes and modifications as fall within the true spirit and scope of the invention.

What is claimed is:

1. An apparatus for protecting an automobile frame comprising:
a flexible magnetic strip having two opposing surfaces; and
an abrasion-resistant and corrosion-resistant coating disposed on one of the opposing surfaces, whereby the apparatus is adapted to be magnetically attached to an automobile frame on the underside of an automobile where it is likely to come into contact with garage jacks and road debris instead of the frame directly.

2. The apparatus of claim 1, wherein the coating is a polyurethane and polyurea coating.

3. The apparatus of claim 1, further comprising an adhesive disposed on a surface of the strip opposite the coating, thereby enhancing the ability of the strip to adhere to an automobile frame.

4. The apparatus of claim 3, further comprising a paper backing disposed on the adhesive.

5. The apparatus of claim 1, wherein the apparatus is in a rolled up configuration.

6. The apparatus claim 1, wherein the strip is at least about 0.32 cm thick.

7. The apparatus of claim 1, wherein the strip is sufficiently long to span the jacking points underneath a car frame.

8. The apparatus of claim 1, wherein the width of the strip is the same or less than the width of an automobile frame.

9. An apparatus for protecting a truck rail comprising:
a flexible magnetic strip having two opposing surfaces; and
an abrasion-resistant and corrosion-resistant coating disposed on one of the opposing surfaces, whereby the apparatus is adapted to be magnetically attached to an truck rail on a top side of a truck bed where it is likely to come into contact with a load placed on the truck to prevent damage to the truck rail.

10. The apparatus of claim 9, wherein the coating is a polyurethane and polyurea coating.

11. The apparatus of claim 9, further comprising an adhesive disposed on a surface of the strip opposite the coating, thereby enhancing the ability of the strip to adhere to truck rail.

12. The apparatus of claim 11, further comprising a paper backing disposed on the adhesive.

13. The apparatus of claim 9, wherein the apparatus is in a rolled up configuration.

14. The apparatus claim 9, wherein the strip is at least about 0.32 cm thick.

15. The apparatus of claim 9, wherein the strip is sufficiently long to span the distance between post holes in a truck rail to which the apparatus is applied.

16. The apparatus of claim 9, wherein the width of the strip is the same or less than the width of a truck rail.

17. A kit for an apparatus that protects a vehicle surface when assembled, the kit comprising;
a plurality of flexible magnetic strips, each having two opposing surfaces; and
an abrasion-resistant and corrosion-resistant coating disposed on one of the opposing surfaces.

18. The kit of claim 17, wherein the coating is a polyurethane and polyurea coating.

19. The kit of claim 17, wherein the apparatus is provided in a rolled up configuration.

20. The kit of claim 17, further comprising an adhesive disposed on a surface of the strip opposite the coating.
